(19) United States
(12) Patent Application Publication
(10) Pub. No.: US 2010/0143110 A1
(43) Pub. Date: Jun. 10, 2010

(54) VANE FOR A COMPRESSOR OR A TURBINE OF AN AIRCRAFT ENGINE, AIRCRAFT ENGINE COMPRISING SUCH A VANE AND A METHOD FOR COATING A VANE OF AN AIRCRAFT ENGINE

(75) Inventors: Thomas Uihlein, Dachau (DE); Wolfgang Eichmann, Puchheim (DE); Falko Heutling, Munchen (DE); Markus Uecker, Munchen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Areo Engines GmbH, Münich (DE)

(21) Appl. No.: 12/513,281

(22) PCT Filed: Oct. 27, 2007
(86) PCT No.: PCT/DE2007/001933

§ 371 Date: Feb. 12, 2010

(30) Foreign Application Priority Data
Nov. 3, 2006 (DE) 10 2006 051 813.6

(51) Int. Cl. F01D 9/02; B05D 5/00

(52) U.S. Cl. 415/208.1; 427/256

(57) ABSTRACT

An aircraft engine comprising a compressor and at least one turbine is disclosed. The compressor and the turbine are each provided with vanes, each of which has a blade that forms a suction side and a pressure side, where at least one first of the blades is coated with a protective layer in order to reduce the erosion or wear. The layer is applied such that at least two areas are formed that adjoin each other at a boundary line. The first area has a protective layer that has a substantially constant first thickness and the second area is free of the protective layer or has the protective layer with a substantially constant second thickness, the second thickness differing from the first thickness. The boundary line has at least two points, of which the connecting line differs from the course of the boundary line between the two points.

This application claims the priority of International Application No. PCT/DE2007/001933, filed Oct. 27, 2007, and German Patent Document No. 10 2006 051 813.6, filed Nov. 3, 2006, the disclosures of which are expressly incorporated by reference herein.

### BACKGROUND AND SUMMARY OF THE INVENTION

The invention relates to an aircraft engine comprising a compressor and at least one turbine, a vane for a compressor or a turbine of an aircraft engine as well as a method for coating a vane of an aircraft engine.

A vane of a gas turbine having a blade and a blade root in which the entire vane is provided with a wear protection coating is already known from German Patent Document No. DE 10 2004 001 392 A1. This wear protection coating is embodied in this case as a multilayer coating system with four different layers.

Regardless of their type, coatings frequently exert a negative impact on the fatigue strength and/or service life of components. This applies in particular to hard material coatings against wear or corrosion, wherein there is a risk that incipient cracks in the ceramic coatings will quickly run into the base material and lead to premature failure of the component.

Furthermore, DE 10 2004 001 392 A1 explains that it is also possible to provide the vanes with a wear protection coating only in sections, and namely in the region of the blade or in parts thereof or in the region of the blade root.

The applicant is aware of these types of designs insofar as frequently only the upper third or the radial outer third of a rotating blade is coated, as the FIG. 1a prepared by the applicant shows in which a vane 101 having a blade 110, a blade root 112, a platform 114 and an erosion protection coating 116 are depicted schematically. This leads to the risk, however, that a particle stream in the transition region will eat away the base material, erode the coating and produce the formation of notches, wherein premature failure in the case of vibrational stress may occur. In order to avoid this, the coating may be dispensed with completely and increased erosion or increased wear accepted in return.

With this background, the invention is based on the objective of creating compressor or turbine vanes of aircraft engines having high corrosion or erosion resistance and good fatigue strength.

According to the invention, an aircraft engine comprising at least one compressor and at least one turbine is provided. The compressor and the turbine are each provided with vanes, namely compressor vanes or turbine vanes. The vanes each form a blade, which have a suction side and a pressure side, as is customarily the case with compressor blades or turbine blade. At least one first of the blades is coated with a protective layer in order to reduce the erosion or wear, which is applied to at least one side of this first blade, i.e., on the pressure side and/or the suction side, in such a way that at least two areas are formed that adjoin each other at a boundary line, of which a first area is provided with the protective layer in such way that the protective layer has a substantially constant first thickness in the first area, and of which a second area (situated especially on the same side as the first area) is free of the protective layer or is provided with the protective layer in such a way that the protective layer has a substantially constant second thickness in the second area, the second thickness differing from the first thickness.

It is now provided that the boundary line separating the first area from the second area, is designed so that there are at least two points of the boundary line, whose connecting line differs from the course of the boundary line between the two points or is not congruent with the course of the boundary line between the two points. This may be such that the corresponding line is such that it does not intersect the boundary line. However, it may also be provided that the line intersects the boundary line.

The first blade in this case may be a blade of a turbine vane or a blade of a compressor vane. It may also be provided that at least one turbine blade and at least one compressor blade is a first blade or is embodied in the inventive manner. It may also be that the first vane is embodied in the inventive manner on its suction side and/or on its pressure side. In an advantageous embodiment, the blades of several, preferably all, turbine vanes and/or compressor vanes are designed as first blades or in the inventive manner.

The first and/or second area mentioned in this case may be an area which extends up the outer edge of the blade, or an area which is essentially closed.

The vane in this case may be a compressor vane or a turbine vane of an engine.

The vane may be embodied in such a way that it forms a platform from which the blade projects. The vane has a blade root in particular. In principle, the invention may relate also to blisks or the like, for example.

An especially advantageous embodiment of the invention provides that the vanes or the vanes embodied in the inventive manner are designed to be one piece, and, in doing so, features in particular a blade root and a blade. Except for the coating, the vane is manufactured from the same material in an advantageous manner.

The vane may in particular be embodied integrally, i.e., in particular in such a way that a blade and a blade root (and platform as the case may be) are embodied or manufactured from one piece.

In an advantageous embodiment, the vane has at least on its one side, namely the suction and/or pressure side, exactly two areas of the cited types, and thus exactly one boundary line. It may be provided that several areas of the cited type and consequently several boundary lines are provided on the suction side and/or the pressure side.

In an advantageous embodiment, the boundary line has curved sections. It may be provided that the boundary line is formed to be parabolic. The vane may have a blade root for example, wherein the boundary line is designed to be parabolic such that it is open in the direction of the blade root.

In an especially preferred embodiment, it is provided that the position of the boundary line is selected as a function of the maximum vibrational stress (in the blade, which in particular presumably exists during operation in an aircraft engine) and/or as a function of the erosion loads of the blade (which in particular presumably exists during operation in an aircraft engine), which exists or is to be anticipated on the forward and rear edges of the blade or from the area on the suction side or the pressure side extending two-dimensionally in the width. In particular, this may be such that the areas are selected so that the locations where said stress maximums exist, are in an area or are each in an area, where no protective layer is provided, or where there is a protective layer with a smaller thickness than at other locations on the same side of the blade. In doing so, particularly continuous stress, dynamic stress and residual stress may be taken into consideration.

The presumable stress and/or erosion loads may be determined for example by means of simulation and/or on the basis of empirical values or in another manner.

It may be provided that two areas are provided on the suction side, which differ in terms of the thickness of their protective layers, or due to the fact that there is a protective layer in one of these areas and that there is no protective layer in the other of these two areas, wherein the following applies for the boundary line separating these two areas from each other:

$$y = 1.1 \times {h}_{1} + \frac{1.1 \times ( {L}^{2} \times ( {h}_{3} - {h}_{1} ) - {L}_{3}^{2} \times ( {h}_{2} - {h}_{1} ) )}{L \times ( L \times {L}_{3} - {L}_{3}^{2} )} \times x + \frac{1.1 \times ( {h}_{2} - {h}_{1} - \frac{1.1 \times ( {L}^{2} \times ( {h}_{3} - {h}_{1} ) - {L}_{3}^{2} \times ( {h}_{2} - {h}_{1} ) )}{L \times ( L \times {L}_{3} - {L}_{3}^{2} )} )}{{L}^{2}} \times {x}^{2}$$

(for simplified reference, this interrelationship is designated as Formula 1) wherein the following applies:

h₁: Measured height above the hub section of the location of the maximum 1F vibrational stress on the forward edge;

h₂: Measured height above the hub section of the location of the maximum 1F vibrational stress (=vibrational stress of the first bending stress) on the rear edge;

h₃: Measured height above the hub section of the location of the maximum 1F vibrational stress on the suction side;

L: Total grille length or axial position of the rear edge in the channel center related to the forward edge in the channel center; and

L₃: Axial position of the location of the maximum 1F vibrational stress on the suction side on the forward edge.

As an alternative or supplement, it may also be provided that two areas are provided on the pressure side, which differ in terms of the thickness of their protective layers, or due to the fact that there is a protective layer in one of these areas and that there is no protective layer in the other of these two areas, wherein the following applies for the boundary line separating these two areas from each other:

$$y = 1.1 \times {h}_{2} + \frac{0.88 \times ( 1.5 \times {h}_{1} - {h}_{2} )}{L} \times x + \frac{0.22 \times ( {h}_{1} + {h}_{2} )}{{L}^{2}} \times {x}^{2}$$

(for simplified reference, this interrelationship is designated as Formula 2)

Reference is made to the explanation above with respect to the meaning of the parameters h₁, h₂ and L.

Exemplary progressions for a respective boundary line in the x-y direction are indicated by the formulae 1 and 2. However, the formula values or the formulae 1 and 2 only represent preferred examples. Instead of the factor 1.1, values between 1.0 and 1.5 may also be used for example. The formula or the formulae 1 and 2 for the parabola or parabolas may also be expanded to include the coordinate z as necessary.

The formulae 1 and 2 relate in particular to an x-y coordinate system, in which the origin is situated in such a way that, in the case of a design with a platform, x=0 on the platform forward edge (on the inlet forward edge) and y=0 on the side of the platform facing the blade in the area of the forward edge of the platform or of the inlet ledge.

The 1F vibrational stress is in particular the vibrational stress of the first bending stress. The channel center is in particular essentially the center between the surface of the platform facing the blade and the housing that is situated to the radial outside from here in the radial direction; the channel center of multiple vanes held in an aircraft engine on the same rotor or the same rotor disk defines essentially a hollow cylinder shape for the arrangement of same.

The boundary line may also be associated with permissible repair areas for panels or patches. In addition, this may mean that decoating is not required in the course of repair work if the erosion-endangered areas coincide with the permissible repair areas and they are removed mechanically with the used layers in any event. In other words, recoating is then possible without prior decoating.

The layer is preferably a multilayer coat.

An inventive method provides for determining stress, in particular stress maximums, to which the vane is subjected during a predetermined operation in a predetermined aircraft engine or in operation, which can occur with respect to the pressure side and/or suction side. Determining the stress or stress maximums may for example be accomplished on the basis of empirical values or on the basis of calculations or experientially or in another manner.

Prior to this, following this or at the same time, an erosion load is determined, to which the vane will presumably be subjected during operation. This may take place for example on the basis of empirical values.

Furthermore, it is provided that areas of the blade of the vane be determined, which should not be coated or should be coated with a reduced layer thickness as compared to other areas of the blade, wherein these determinations are made as a function of the stress determined and the erosion load determined.

Finally, the vane or the blade is coated, and namely taking into consideration the determination of the areas of the blade or the vane, which are not supposed to be coated or are supposed to be coated with a reduced layer thickness.

It must be noted that the inventive method may be embodied with respect to the pressure side of a blade and/or with respect to the suction side of a blade.

According to an especially preferred embodiment, it is provided in particular that, for example, multilayer coats with a low influence on fatigue strength are used and/or layers are omitted only in the transition area from the platform to the blade, where there is only slight erosion attack, and/or in areas where stress maximums of the vibration are present. The following procedure may be used in an advantageous embodiment. To begin with, the stress maximums may be determined. Then, an overlay with an erosion image on a simulation program for particle erosion, such as, for example, CFX5 from ANSYS Co., may take place. Then, areas may be determined, which are not supposed to be coated or are supposed to be coated less. Moreover, it may be provided that these areas are then shaded, which can be accomplished using devices or procedures that are known to a person skilled in the art.

It must be noted that empirically determined (simulation) images of already known components may be used instead of particle simulation programs.

An advantageous embodiment provides that the step of decoating prior to recoating is dispensed with, if permissible repair areas with optimized coating areas coincide with the area of the erosion attack.

### BRIEF DESCRIPTION OF THE DRAWINGS

Exemplary embodiments of the invention will be explained in the following on the basis of the figures. They show:

FIG. 1a is known design;

FIG. 1b is a schematic view of an exemplary inventive embodiment;

FIG. 2 is a schematic view of a vane with schematic and exemplary added zones with erosion loads of different strengths; and

FIG. 3 is an exemplary inventive blade shown from its suction side.

### DETAILED DESCRIPTION OF THE DRAWINGS

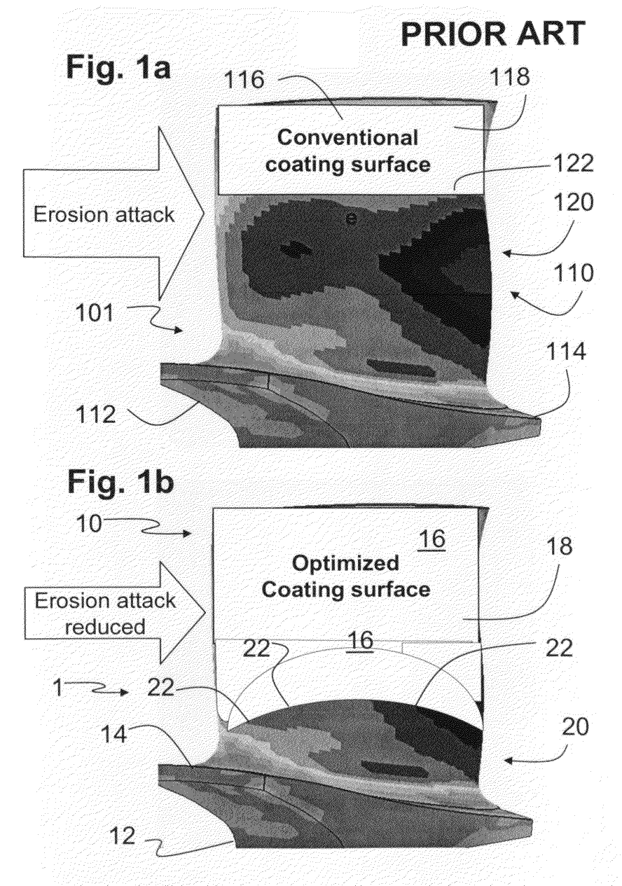

FIG. 1b shows an embodiment of a vane 1 of an aircraft engine that has been modified as compared to FIG. 1a, wherein the embodiment in FIG. 1a that has already been addressed introductorily features a conventional coating surface and the embodiment in FIG. 1b is an exemplary inventive embodiment.

As FIG. 1b shows, the vane 1 there has a blade 10, a blade root 12, which is depicted partially in this figure, as well as a platform 14. The platform 14 separates the blade 10 from the blade root 12. The blade 10 has a coating 16 on its pressure side and/or its suction side.

The blade 10 has a coating 16 in its suction side and/or pressure side.

A first area 18 as well as a second area 20 is embodied on the suction side and/or the pressure side of this blade 10, wherein this first area and this second area adjoin one another at a boundary line 22. The exemplary embodiment in FIG. 1b provides that the already addressed coating or protective layer 16 is provided in the first area 18, and the second area 20 is free of this type of protective layer. As an alternative, however, it may also be provided for example that the first area 18 and the second area 20 each have a protective layer, wherein these two protective layers or areas 18, 20 differ in terms of the thickness of their protective layers. In particular, this may be such that the protective layer or coating in the first area 18 is thicker than in the second area 20.

In contrast to the embodiment in FIG. 1a, in which the boundary line 122 there between the first 118 and the second area 120 lies completely on a straight line, in the case of the boundary line 22 in FIG. 1b, there are at least two points on the boundary line 22, whose connecting line differs from the course of the boundary line between the two points.

In other words, the boundary line 22 according to FIG. 1b is not completely situated on a straight line.

The boundary line 22 according to FIG. 1b is curved in this case, and namely designed to be parabolic in particular. As FIG. 1b clearly shows, the curvature there is concave or the parabola shape is open in the direction of the blade root 12 or the platform 14.

The parabola shape may have a course in this case corresponding to that of formula 1 or correspond to that of formula 2.

As compared with the embodiment in FIG. 1a, the erosion attack is reduced in the embodiment in FIG. 1b, and namely in particular based on the formation of the protective layer or coating surface there.

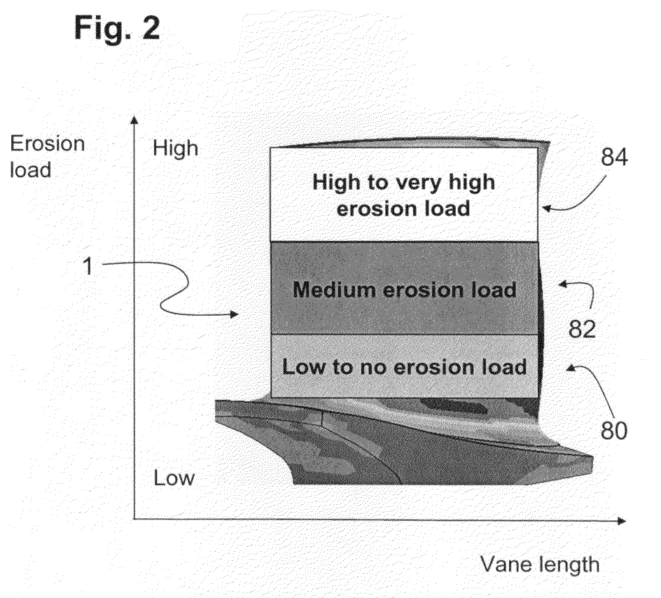

FIG. 2 schematically shows a vane as well as an exemplary erosion load over the vane length or vane height. This erosion load may be determined for example by a particle simulation program or empirical experience or the like.

The exemplary erosion load depicted in FIG. 2 is such that the blade 10 in an area 80, which is situated in the vicinity of the blade root 12, is subjected to slight to no erosion load, and with increasing distance from the blade root 12 (stepped as the case may be) is subjected to an increasing erosion load, which can be split schematically into an area 82 with medium erosion load and an area 84 with high to very high erosion load.

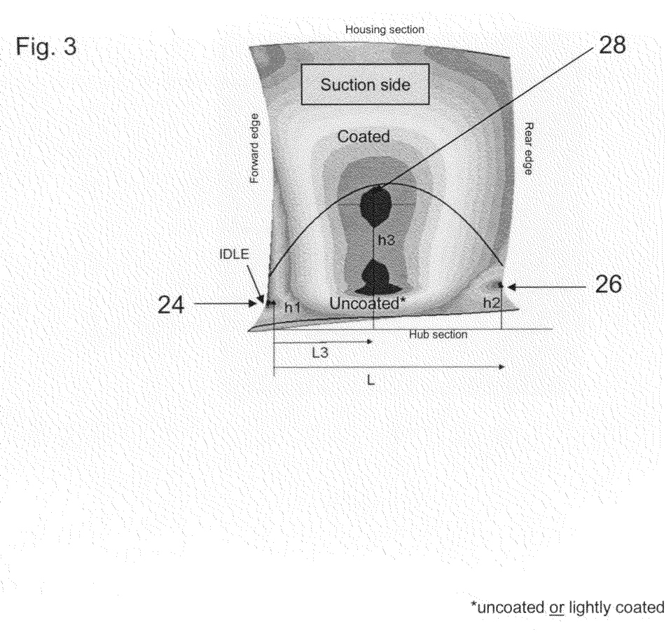

FIG. 3 schematically depicts an exemplary inventive blade 10, and namely in a view of its suction side.

FIG. 3 schematically depicts a stress profile on the blade 10, which may develop during operation of the vane or the blade 10 in a compressor or a turbine of an aircraft engine. The stress profile may be determined empirically from empirical values or be calculated or determined in another manner.

The reference number 24 in this case indicates the maximum 1F vibrational stress on the forward edge. The reference number 26 in this case indicates the maximum 1F vibrational stress on the rear edge and the reference number 28 indicates the maximum 1F vibrational stress on the suction side.

As the view of the suction side of the blade 10 in FIG. 3 clearly shows, a coating 16 is provided in the radial outer area or in the first area 18. The second area 20 is uncoated or slightly coated or provided with a thinner coating than the first area 18. The first area 18 is separated from the second area 20 by a boundary line 22 or the areas 18 and 20 adjoin at the boundary line 22, wherein the boundary line 22 has a course with the parameters indicated in the legend in FIG. 3, which is embodied in accordance with the forgoing formula 1.

This type of boundary line, which separates a coated from an uncoated or less coated area, may also be provided on the pressure side that is not depicted in FIG. 3, wherein the boundary line in this case preferably runs, in accordance with formula 2, which is indicated above. The coated or more heavily coated area on the pressure side is then also on the radial outside.

The zero point of the graphs or of the corresponding coordinate system may lie at the point that is indicated in FIG. 3 with IDLE, i.e., at the point that was cited above.

Vanes in particular may be stressed with the greatest intensities from bending and torsion modes in the case of loads from pumps or fluttering. The maximums of these modes (critical stress peaks) are frequently localized in the lower half of the blade. No layer boundary should run in these areas or rather it is expedient if no layer boundary runs in these areas or at least the layer thickness should be reduced or rather it is expedient if the layer thickness is reduced.

In this case, there is frequently higher stress on the suction side than on the pressure side; i.e., if appreciably more wear also occurs in the suction area, a differentiation must still be made as the case may be between the suction side and the pressure side in the case of the local coating, which may also be different however.

As explained above, a boundary line (especially a parabola or embodied as a parabola) may be described to some extent, which differentiates areas, which may be without a coating and may be coated with a limitation, as is the case in an advantageous embodiment of the invention for example.

The following legend applies with reference to FIG. 3:

Legend:

The zero point for the graphs is IDLE (=inner diameter leading edge, see FIG. 3);

h₁: Measured height above the hub section (see image) of the location of the maximum 1F vibrational stress on the forward edge;

h₂: Measured height above the hub section of the location of the maximum 1F vibrational stress on the rear edge;

h₃: Measured height above the hub section of the location of the maximum 1F vibrational stress on the suction side;

L: Total grille length or axial position of the rear edge in the channel center related to the forward edge in the channel center; and

L₃: Axial position of the location of the maximum 1F vibrational stress on the suction side on the forward edge.

1-9. (canceled)

10. An aircraft engine comprising a compressor and at least one turbine, wherein the compressor and the turbine are each provided with vanes, each of which has a blade that forms a suction side and a pressure side, wherein at least one first of the blades is coated with a protective layer in order to reduce an erosion or wear, which protective layer is applied to at least one side of the blade such that at least two areas are formed that adjoin each other at a boundary line, wherein a first area is provided with the protective layer such that the protective layer has a substantially constant first thickness in the first area, and wherein a second area is free of the protective layer or is provided with the protective layer such that the protective layer has a substantially constant second thickness in the second area, the second thickness differing from the first thickness, and wherein the boundary line has at least two points, where a straight line connecting the two points differs from a course of the boundary line between the two points.

11. A vane for a compressor or a turbine of an aircraft engine, comprising a blade that forms a suction side and a pressure side, which is coated with a protective layer in order to reduce an erosion or wear, which protective layer is applied to at least one side of the blade such that at least two areas are formed that adjoin each other at a boundary line, wherein a first area is provided with the protective layer such that the protective layer has a substantially constant first thickness in the first area, and wherein a second area is free of the protective layer or is provided with the protective layer such that the protective layer has a substantially constant second thickness in the second area, the second thickness differing from the first thickness, and wherein the boundary line has at least two points, where a straight line connecting the two points differs from a course of the boundary line between the two points.

12. The vane according to claim 11, wherein the boundary line has a parabola shape.

13. The vane according to claim 12, wherein the vane has a blade root and wherein the parabola shape is open in a direction of the blade root.

14. The vane according to claim 11, wherein, as a function of a maximum 1F vibrational stress occurring during operation of the vane in an aircraft engine on a rear edge, and as a function of a maximum 1F vibrational stress occurring during operation of the vane in an aircraft engine on a forward edge, and as a function of a maximum 1F vibrational stress occurring during operation of the vane in an aircraft engine on the side of the blade which is coated with the protective layer, the boundary line runs such that the three maximum 1F stresses are applied to a same side of the boundary line.

15. The vane according to claim 11, wherein there is at least one or exactly one boundary line on the suction side, wherein for the at least one or the exactly one boundary line a following equation applies:
$$y = 1.1 \times {h}_{1} + \frac{1.1 \times ( {L}^{2} \times ( {h}_{3} - {h}_{1} ) - {L}_{3}^{2} \times ( {h}_{2} - {h}_{1} ) )}{L \times ( L \times {L}_{3} - {L}_{3}^{2} )} \times x + \frac{1.1 \times ( {h}_{2} - {h}_{1} - \frac{1.1 \times ( {L}^{2} \times ( {h}_{3} - {h}_{1} ) - {L}_{3}^{2} \times ( {h}_{2} - {h}_{1} ) )}{L \times ( L \times {L}_{3} - {L}_{3}^{2} )} )}{{L}^{2}} \times {x}^{2}$$
wherein in the following equation:
h₁: is a measured height above a hub section of a location of the maximum 1F vibrational stress on the forward edge;
h₂: is a measured height above the hub section of a location of the maximum 1F vibrational stress on the rear edge;
h₃: is a measured height above the hub section of a location of the maximum 1F vibrational stress on the suction side;
L: is a total grille length or axial position of the rear edge in a channel center related to the forward edge in the channel center; and
L₃: is an axial position of the location of the maximum 1F vibrational stress on the suction side on the forward edge.

16. The vane according to claim 11, wherein there is at least one or exactly one boundary line on the pressure side, wherein for the at least one or the exactly one boundary line a following equation applies:
$$y = 1.1 \times {h}_{2} + \frac{0.88 \times ( 1.5 \times {h}_{1} - {h}_{2} )}{L} \times x + \frac{0.22 \times ( {h}_{1} + {h}_{2} )}{{L}^{2}} \times {x}^{2}$$
wherein in the following equation:
h₁: is a measured height above a hub section of a location of the maximum 1F vibrational stress on the forward edge;
h₂: is a measured height above the hub section of a location of the maximum 1F vibrational stress on the rear edge; and
L: is a total grille length or axial position of the rear edge in a channel center related to the forward edge in the channel center.

17. A method for coating a vane of an aircraft engine, comprising the steps of:
determining a stress to which the vane will be subjected during a predetermined operation in a predetermined aircraft engine during operation;
determining an erosion load to which the vane will be subjected during operation;
determining areas of a blade of the vane which should not be coated or should be coated with a reduced layer thickness as compared to other areas of the blade, wherein this determination is made as a function of the stress determined and the erosion load determined; and
coating the blade based on the determination of the areas of the blade which are not to be coated or are to be coated with a reduced layer thickness.

18. The method according to claim 17, wherein the vane is a turbine vane or compressor vane.
